(19) United States
(12) Patent Application Publication
(10) Pub. No.: US 2026/0175234 A1
(43) Pub. Date: Jun. 25, 2026

(54) FLOTATION RECOVERY METHODS FOR FULL PARTICLE SIZE COPPER ORE

(71) Applicant: CENTRAL SOUTH UNIVERSITY, Changsha (CN)

(72) Inventors: Feng JIANG, Changsha (CN); Wei SUN, Changsha (CN); Honghu TANG, Changsha (CN); Jian PENG, Changsha (CN); Haisheng HAN, Changsha (CN); Li WANG, Changsha (CN); Lei SUN, Changsha (CN); Yuanjia LUO, Changsha (CN)

(73) Assignee: CENTRAL SOUTH UNIVERSITY, Changsha (CN)

(21) Appl. No.: 19/430,358

(22) Filed: Dec. 23, 2025

(30) Foreign Application Priority Data
Dec. 23, 2024 (CN) 202411898193.7

(51) Int. Cl. B03D 1/008; B03D 1/012

(52) U.S. Cl. CPC B03D 1/008; B03D 1/012; B03D 2203/04

(57) ABSTRACT

Provided is a flotation recovery method for a full particle size copper ore, including: performing grinding and dissociation treatment on a copper raw ore, and then performing primary roughing; performing classification on the copper rough tailings to obtain a +200 mesh slurry product, a 200-400 mesh slurry product, and a −400 mesh slurry product, which are three particle size slurry products; performing coarse particle flotation on the +200 mesh slurry product, and recovering coarse particle copper ore using a combined collector of diisopropyl xanthogen disulfide and isopropyl xanthate, wherein a rough concentrate obtained is returned to a grinding operation; performing fine particle flotation on the −400 mesh slurry product using a fine particle flotation collector, and combining an obtained rough concentrate with a copper rough concentrate from the primary roughing to perform cleaning; and directly using the 200-400 mesh slurry product as tailings.

### CROSS-REFERENCE TO RELATED APPLICATIONS

This application claims priority to the Chinese Patent Application No. 202411898193.7, filed on Dec. 23, 2024, the contents of which are hereby incorporated by reference.

### TECHNICAL FIELD

The present disclosure generally relates to a field of copper ore separation technology, and in particular to a flotation recovery method for a full particle size copper ore.

### BACKGROUND

As a strategic metal resource, copper is widely used in fields such as new energy, construction, transportation, and electronics. Copper sulfide ore is a main source of copper resources. Currently, a preferential flotation process is mainly used for copper sulfide ore. In the flotation process, inhibitors such as lime are added to suppress pyrite, and collectors such as Z-200 and butyl xanthate are used to selectively float copper sulfide ore. However, in actual production processes, due to large processing volumes, the ore grinding process often results in a “large at both ends, small in the middle” issue. That is, the +200 mesh and −400 mesh particle size fractions account for a relatively large proportion, while the 200-400 mesh particle size fraction accounts for a small proportion. Since traditional flotation processes mainly target the recovery of ore of the 200-400 mesh particle size, aspects such as process design, equipment selection, and reagent regime setting tend to overlook the recovery of coarse and fine particle ore. Consequently, a large amount of coarse and fine copper ore is lost in the tailings during the flotation process, resulting in severe resource loss.

Therefore, there is an urgent need to provide an efficient flotation recovery method for full particle size copper ore to ensure efficient recovery and utilization of copper resources.

### SUMMARY

One or more embodiments of the present disclosure provide a flotation recovery method for a full particle size copper ore, comprising the following steps:
a) performing grinding and dissociation treatment on a copper raw ore, adding a flotation reagent, and performing flotation, wherein the flotation includes primary roughing to obtain a copper rough concentrate and copper rough tailings;
b) performing classification on the copper rough tailings to obtain a +200 mesh slurry product, a 200-400 mesh slurry product, and a −400 mesh slurry product, which are three particle size slurry products;
c) adding a combined collector of diisopropyl xanthogen disulfide and isopropyl xanthate to the +200 mesh slurry product and performing coarse particle flotation to obtain a rough concentrate of the coarse particle flotation and tailings of the coarse particle flotation, wherein a mass ratio of diisopropyl xanthogen disulfide to isopropyl xanthate in the combined collector of diisopropyl xanthogen disulfide and isopropyl xanthate is (3-1):1;
d) performing fine particle rougher flotation on the −400 mesh slurry product, adding a fine particle flotation collector during a process of the fine particle rougher flotation to obtain a rough concentrate of fine particle flotation and tailings of the fine particle rougher flotation, combining the rough concentrate of fine particle flotation with the copper rough concentrate obtained in step a), and performing blank cleaning to obtain a copper concentrate; performing scavenging on the tailings of the fine particle rougher flotation to obtain tailings of fine particle flotation, wherein the fine particle flotation collector includes a long-chain alkyl xanthate and a neutral oil at a mass ratio of (1-2):(1-2), the long-chain alkyl xanthate includes at least one of butyl xanthate, pentyl xanthate, and isopentyl xanthate; and the neutral oil includes at least one of kerosene, diesel oil, transformer oil, lubricating oil, and heavy oil;
e) combining the 200-400 mesh slurry product, the tailings of the coarse particle flotation obtained in step c), and the tailings of fine particle flotation obtained in step d) as final flotation tailings.

### BRIEF DESCRIPTION OF THE DRAWINGS

FIG. 1 is a flowchart illustrating a process of a closed-circuit test used in some embodiments of the present disclosure.

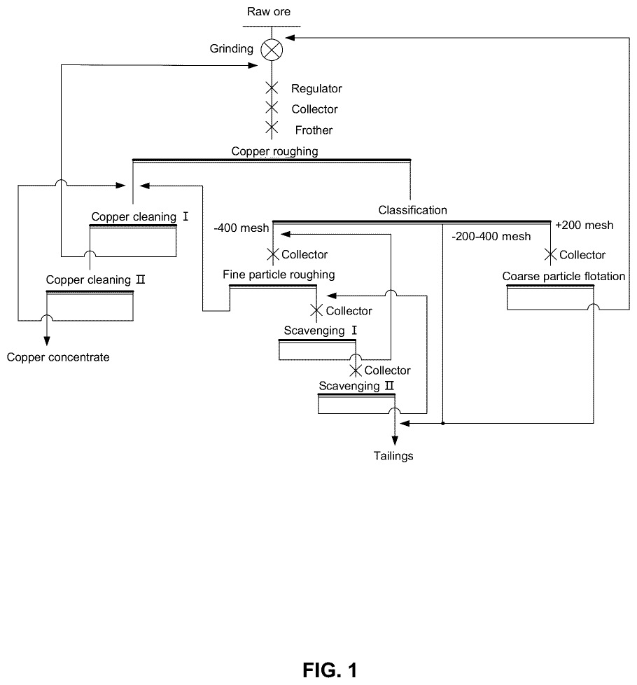

FIG. 2 is a flowchart illustrating a process of a closed-circuit test used in Comparative EXAMPLE 1.

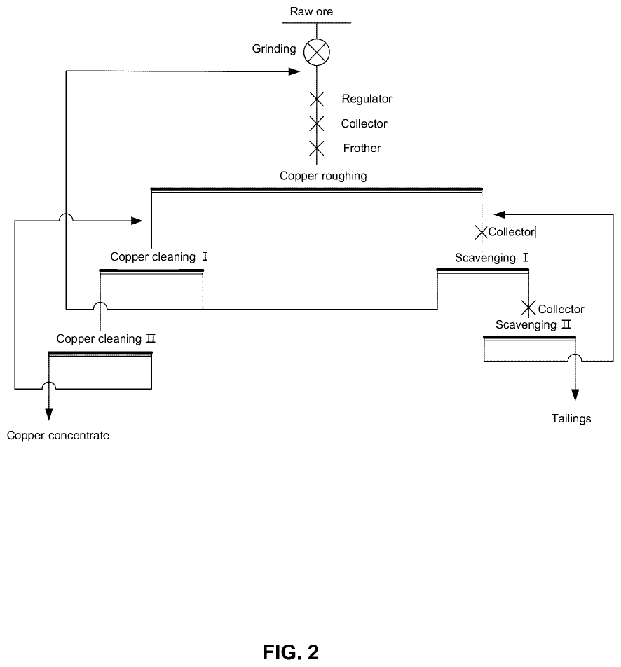

### DETAILED DESCRIPTION

To further illustrate the present disclosure, the content of the present disclosure is described in detail below in conjunction with embodiments. It should be understood that these embodiments are implemented based on the technical solution of the present disclosure. These embodiments provide detailed implementation methods and specific operation processes, which are only intended to further illustrate the features and advantages of the present disclosure, rather than limiting the claims of the present disclosure. The protection scope of the present disclosure is also not limited to the following embodiments.

Aiming at the problem of loss of coarse and fine copper ore in existing flotation recovery manners for copper ore, the purpose of the present disclosure is to provide a flotation recovery method for a full particle size copper ore. By classifying the copper ore of different particle sizes and using different collector combinations for coarse and fine particles, the recovery of copper ore in the coarse and fine particles is enhanced, achieving full particle size flotation recovery of copper ore. In addition, for coarse copper ore, the synergistic effect of diisopropyl xanthogen disulfide and isopropyl xanthate significantly improves the adhesion of coarse copper particles to bubbles.

To achieve the above technical purpose, the present disclosure provides a flotation recovery method for a full particle size copper ore. The method includes the following steps:
a) performing grinding and dissociation treatment on a copper raw ore, adding a flotation reagent, and performing flotation, wherein the flotation includes primary roughing to obtain a copper rough concentrate and copper rough tailings;
b) performing classification on the copper rough tailings to obtain a +200 mesh slurry product, a 200-400 mesh slurry product, and a −400 mesh slurry product, which are three particle size slurry products;
c) adding a combined collector of diisopropyl xanthogen disulfide and isopropyl xanthate to the +200 mesh slurry product and performing coarse particle flotation to obtain a rough concentrate of the coarse particle flotation and tailings of the coarse particle flotation, wherein a mass ratio of diisopropyl xanthogen disulfide to isopropyl xanthate in the combined collector of diisopropyl xanthogen disulfide and isopropyl xanthate is (3-1):1;

d) performing fine particle rougher flotation on the −400 mesh slurry product, adding a fine particle flotation collector during a process of the fine particle rougher flotation to obtain a rough concentrate of fine particle flotation and tailings of the fine particle rougher flotation, combining the rough concentrate of fine particle flotation with the copper rough concentrate obtained in step a), and performing blank cleaning to obtain a copper concentrate; performing scavenging on the tailings of the fine particle rougher flotation to obtain tailings of fine particle flotation, wherein the fine particle flotation collector includes a long-chain alkyl xanthate and a neutral oil at a mass ratio of (1-2):(1-2), the long-chain alkyl xanthate includes at least one of butyl xanthate, pentyl xanthate, and isopentyl xanthate; and the neutral oil includes at least one of kerosene, diesel oil, transformer oil, lubricating oil, and heavy oil;
e) combining the 200-400 mesh slurry product, the tailings of the coarse particle flotation obtained in step c), and the tailings of fine particle flotation obtained in step d) as final flotation tailings.

Regarding step a), performing grinding and dissociation treatment on a copper raw ore, adding a flotation reagent, and performing flotation, wherein the flotation includes primary roughing to obtain a copper rough concentrate and copper rough tailings.

The copper raw ore refers to raw copper ore mined from a mine and not subjected to beneficiation treatment. The copper raw ore includes a plurality of minerals, such as chalcopyrite, bornite, pyrite, etc., and has a low copper grade (e.g., 0.34% to 0.50%).

The copper rough concentrate refers to a preliminary enrichment product obtained after roughing of the copper raw ore. The copper grade is higher than that of the raw ore, but further cleaning is required. The copper rough concentrate includes ore of a conventional particle size of 200 to 400 mesh. The copper rough tailings refer to ore particles not floated out during the roughing process, and have a low copper grade.

The grinding and dissociation treatment refers to crushing the copper raw ore to a certain fineness through grinding equipment to dissociate valuable ore from gangue minerals.

Flotation refers to selectively separating metal ore (e.g., copper ore) from gangue minerals (useless rock) in ore by utilizing differences in surface properties of mineral particles (hydrophobicity/hydrophilicity) and the adsorption effect of bubbles.

The flotation reagent refers to a chemical reagent added during the flotation process. The flotation reagent is used to adjust surface properties of ore, promote bubble attachment, etc. The flotation reagent may include a regulator, a collector I, a frother, etc. The regulator refers to a reagent used to adjust the chemical environment of the slurry (e.g., pH value) and surface properties of ore. The regulator may create optimal working conditions for subsequent collectors and frothers. The collector I refers to a reagent that may selectively adsorb on a surface of a target ore, making it hydrophobic, thereby facilitating attachment to bubbles for flotation. The frother is a surfactant that may reduce a surface tension of water, generating a large count of bubbles with moderate size and stability when the flotation cell is aerated and stirred.

In some embodiments, in step a), a product fineness of the grinding and dissociation treatment is 50% to 75% passing 74 μm. The regulator, the collector I, and the frother are added during the primary roughing of the flotation to promote flotation. In some embodiments, the product fineness of the grinding and dissociation treatment is 55% to 70% passing 74 μm. In some embodiments, the product fineness of the grinding and dissociation treatment is 60% to 70% passing 74 μm. In some embodiments, the product fineness of the grinding and dissociation treatment is 60% to 65% passing 74 μm.

In some embodiments of the present disclosure, by controlling the product fineness of the grinding and dissociation treatment to 50% to 75% passing 74 μm and performing flotation on this product, a floated copper rough concentrate can be directly obtained for subsequent refining. Therefore, subsequent flotation operations only need to be performed on the remaining copper rough tailings that are not floated out, thereby reducing the workload of subsequent flotation and avoiding adverse effects on subsequent fine particle flotation and coarse particle flotation processes.

In some embodiments, the regulator includes at least one of sodium hydroxide, lime, sodium sulfide, sodium hydrosulfide, sodium metabisulfite, and sodium carbonate, and is used in an amount to adjust a slurry pH to 7.5 to 9.5. In an alkaline environment, the collector I reacts more easily with copper ions to form a stable complex, and the foaming property of the frother is also relatively stable.

In some embodiments, the collector I includes at least one of a xanthate collector, a thiocarbamate collector, a dithiophosphate collector, and a thionocarbamate collector, and is used in an amount of 10 to 100 g/t. The xanthate collector is preferably ethyl xanthate or butyl xanthate. The thiocarbamate collector is preferably Z-200 (O-isopropyl-N-ethyl thionocarbamate). The dithiophosphate collector is preferably ammonium dibutyl dithiophosphate. The thionocarbamate collector is preferably diethyl dithiocarbamate or ester 105 (cyanoethyl thionocarbamate). In some embodiments, the collector I is used in an amount of 20 to 60 g/t. In some embodiments, the collector I is used in an amount of 30 to 50 g/t. It should be noted that the dosages of reagents in the present disclosure are all based on the amount of the raw ore (i.e., the copper raw ore).

In some embodiments, the frother includes at least one of oil No. 2 and Methyl Isobutyl Carbinol (MIBC). The oil No. 2 refers to pine oil or terpene alcohol. In some embodiments, the frother is used in an amount of 5 to 30 g/t. In some embodiments, the frother is used in an amount of 10 to 20 g/t.

In some embodiments of the present disclosure, by adjusting the slurry pH to 7.5 to 9.5 with the regulator, the collector I chemically reacts with copper ions to form a stable complex and adheres to bubbles formed by the frother, which can promote the flotation of copper raw ore particles, thereby floating out ore of a specific particle size.

Regarding step b), performing classification on the copper rough tailings to obtain the +200 mesh slurry product, the 200-400 mesh slurry product, and the −400 mesh slurry product, which are three particle size slurry products.

The classification refers to a process of separating the slurry according to particle size. The +200 mesh slurry product refers to a slurry with a particle size larger than 200 mesh, i.e., 0.074 mm. The 200-400 mesh slurry product refers to a slurry with a particle size between 200 mesh and 400 mesh, i.e., 0.037-0.074 mm. The −400 mesh slurry product refers to a slurry with a particle size less than 400 mesh, i.e., 0.037 mm.

In some embodiments, the classification includes at least one of a high-frequency vibrating screen, a hydrocyclone, a spiral classifier, a hydraulic classifier, and a mud bucket. For the high-frequency vibrating screen, vibration frequency of the high-frequency vibrating screen may be 25 Hz to 60 Hz, or another suitable frequency or frequency range. Through the above-mentioned classification equipment, the copper rough tailings can be separated according to particle size, facilitating subsequent coarse particle flotation and fine particle flotation.

Regarding step c), adding a combined collector of diisopropyl xanthogen disulfide and isopropyl xanthate to the +200 mesh slurry product and performing coarse particle flotation to obtain a rough concentrate of the coarse particle flotation and tailings of the coarse particle flotation, wherein a mass ratio of diisopropyl xanthogen disulfide to isopropyl xanthate in the combined collector of diisopropyl xanthogen disulfide and isopropyl xanthate is (3-1):1.

The coarse particle flotation refers to a flotation process targeting coarse particles (the +200 mesh slurry product).

The rough concentrate of the coarse particle flotation refers to an enriched product obtained from the coarse particle flotation. The rough concentrate of the coarse particle flotation is mostly middlings. The tailings of the coarse particle flotation refer to a portion not recovered after the coarse particle flotation. The tailings of the coarse particle flotation may be combined with other tailings.

In some embodiments, the rough concentrate of the coarse particle flotation in step c) is returned to a raw ore grinding operation. In the present disclosure, the rough concentrate obtained from the coarse particle flotation is mostly middlings and needs to be returned to the raw ore grinding for dissociation.

The combined collector of diisopropyl xanthogen disulfide and isopropyl xanthate refers to a collector formed by combining diisopropyl xanthogen disulfide and isopropyl xanthate. A branched-chain structure of diisopropyl xanthogen disulfide may enhance chelation with bubbles and improve adhesion strength. Isopropyl xanthate may strengthen adsorption on copper ore and promote a combined effect.

When the mass ratio of diisopropyl xanthogen disulfide to isopropyl xanthate in the combined collector of diisopropyl xanthogen disulfide and isopropyl xanthate is within a range of (3-1):1, an optimal coarse particle flotation effect is achieved. If a dosage of diisopropyl xanthogen disulfide is too high, it may instead lead to increased loss of coarse particle copper ore and a decrease in copper concentrate recovery. If a dosage of isopropyl xanthate is too high, excessive isopropyl xanthate may cause extensive adsorption of the reagent to adsorb heavily on surfaces of non-copper ore, which reduces flotation selectivity, causing impurity content in the obtained flotation product to increase and concentrate grade to decrease.

In some embodiments, a total dosage of the combined collector of diisopropyl xanthogen disulfide and isopropyl xanthate is 10-50 g/t. In some embodiments, the total dosage of the combined collector of diisopropyl xanthogen disulfide and isopropyl xanthate is 20-40 g/t. In some embodiments, the total dosage of the combined collector of diisopropyl xanthogen disulfide and isopropyl xanthate is 25-35 g/t. By limiting the dosage of the combined collector of diisopropyl xanthogen disulfide and isopropyl xanthate to the above range, the copper concentrate recovery can be ensured while reducing the adsorption of non-copper ore.

Regarding step d), performing fine particle rougher flotation on the −400 mesh slurry product, adding a fine particle flotation collector during a process of the fine particle rougher flotation to obtain a rough concentrate of fine particle flotation and tailings of the fine particle rougher flotation, combining the rough concentrate of fine particle flotation with the copper rough concentrate obtained in step a), and performing blank cleaning to obtain a copper concentrate; performing scavenging on the tailings of the fine particle rougher flotation to obtain tailings of fine particle flotation, wherein the fine particle flotation collector includes a long-chain alkyl xanthate and a neutral oil at a mass ratio of (1-2):(1-2), the long-chain alkyl xanthate includes at least one of butyl xanthate, pentyl xanthate, and isopentyl xanthate; and the neutral oil includes at least one of kerosene, diesel oil, transformer oil, lubricating oil, and heavy oil.

The fine particle rougher flotation refers to a preliminary flotation operation targeting the −400 mesh slurry product.

In some embodiments, in step d), in the fine particle rougher flotation, a slurry concentration is 20-30%, and a stirring speed of a flotation cell is 2000-2400 rpm. During the fine particle rougher flotation process, a lower slurry concentration is used to reduce interference between particles, avoid mutual inclusion of fine ore particles affecting flotation selectivity, and allow more contact opportunities between bubbles and ore particles, and ore particles are more dispersed in a dilute slurry, which facilitates collision and attachment between bubbles and individual particles. A faster stirring speed may provide sufficient energy to break up agglomerated fine ore particles, making the ore particles uniformly dispersed and increasing the probability of contact with bubbles, the faster stirring speed may also accelerate diffusion of reagents in the slurry, allowing reagent molecules to quickly reach surfaces of the ore particles and take effect, which is important for fine ore particles with a large specific surface area. The faster stirring speed may also disperse air into more and smaller bubbles, increasing a count and surface area of bubbles. Small bubbles rise slowly, which may prolong interaction time with ore particles and improve flotation efficiency.

In some embodiments, in step c), a slurry concentration of the coarse particle flotation is 20-50%.

In the present disclosure, the slurry concentration refers to a mass concentration, and reagent dosages are all based on the amount of the raw ore.

The rough concentrate of fine particle flotation refers to an enriched product obtained from the fine particle rougher flotation. The rough concentrate of fine particle flotation may be combined with the copper rough concentrate in step a) for cleaning. The tailings of the fine particle rougher flotation refer to a portion not recovered after the fine particle rougher flotation. The tailings of the fine particle rougher flotation need to enter a scavenging operation for further recovery.

The fine particle flotation collector refers to a collector composed of a long-chain alkyl xanthate and a neutral oil.

In some embodiments, the fine particle flotation collector includes the long-chain alkyl xanthate and the neutral oil in a mass ratio of (1-2):(1-2). Within the selected mass ratio range in the present disclosure, the fine particle flotation collector has an optimal fine particle flotation effect. If a dosage of the long-chain alkyl xanthate is too high, it may lead to increased loss of fine copper ore and a reduction in copper concentrate recovery. If a dosage of the neutral oil is too high, it may cause some non-target ore to be entrained into an oil phase or to agglomerate at boundaries of the oil phase, thereby reducing flotation selectivity and causing concentrate grade to decrease.

In some embodiments, a total dosage of the fine particle flotation collector in the rougher flotation (i.e., the fine particle rougher flotation) process is 20-50 g/t. In some embodiments, the total dosage of the fine particle flotation collector in the rougher flotation process is 25-45 g/t. In some embodiments, the total dosage of the fine particle flotation collector in the rougher flotation process is 30-40 g/t. In some embodiments, the total dosage of the fine particle flotation collector in the scavenging process is 7-20 g/t. In some embodiments, the total dosage of the fine particle flotation collector in the scavenging process is 10-17 g/t. In some embodiments, the total dosage of the fine particle flotation collector in the scavenging process is 12-15 g/t. In some embodiments, types of the fine particle flotation collectors in the rougher flotation process and the scavenging process are the same or different.

The blank cleaning refers to a cleaning process where no reagents are added, and purification of the concentrate relies solely on physical conditions (e.g., bubbles, stirring).

The scavenging refers to performing flotation again on the tailings of the fine particle rougher flotation to recover residual valuable ore.

In some embodiments, the blank cleaning in step d) is performed at least twice, and the scavenging is performed at least twice.

Regarding step e), combining the 200-400 mesh slurry product, the tailings of the coarse particle flotation obtained in step c), and the tailings of fine particle flotation obtained in step d) as final flotation tailings.

The final flotation tailings refer to are residue discarded after all flotation processes are completed. The final flotation tailings include the 200-400 mesh slurry product, the tailings of the coarse particle flotation, the tailings of fine particle flotation, etc.

In some embodiments of the present disclosure, by skillfully combining classification treatment of a copper ore with a combined collector adapted to slurry of copper ores of different particle sizes, full particle size recovery of the copper ore is achieved. Specifically, in some embodiments of the present disclosure, by performing primary roughing on a copper raw ore first, most of the ore in the conventional 200-400 mesh particle size range is recovered, and adverse effects on subsequent fine particle flotation and coarse particle flotation processes are avoided. Then, by performing classification recovery on the copper ore after the primary roughing, wherein the content of 200-400 mesh particle size copper ore after the primary roughing is very low and may be directly treated as the tailings, the +200 mesh and −400 mesh particle sizes are subjected to coarse particle flotation and fine particle flotation technologies, respectively, ensuring efficient recovery of easily floatable copper ore and enhancing recovery of coarse and fine particle size copper ore. For the +200 mesh coarse particles, a combined collector of diisopropyl xanthogen disulfide and isopropyl xanthate has a good collecting effect, and its collection principle is as follows. The branched chain structure in the hydrophobic hydrocarbon chain of diisopropyl xanthogen disulfide may form a chelate-like effect with bubbles, improving adhesion strength between coarse particle copper ore and the bubbles. Meanwhile, the molecular structure contains two isopropyl xanthate groups. During the flotation process, sulfur atoms in diisopropyl xanthogen disulfide molecule undergo a chemical reaction with copper ions on the surface of the copper are, forming a copper sulfide compound, thereby making the surface of the copper are hydrophobic and easy to adhere to bubbles and be carried to the surface of the slurry. Isopropyl xanthate has a strong adsorption effect on copper ore particles, further promoting the interaction between diisopropyl xanthogen disulfide and bubbles. The synergistic use of the two significantly improves the stable adhesion of coarse particle copper ore to bubbles. For the −400 mesh fine particles, a long-chain xanthate is used to promote interaction between fine particle copper ore and the collector, improving the hydrophobicity of the fine particle copper ore. Meanwhile, a neutral oil is combined to improve the aggregation of hydrophobic fine particle copper ore within or at the boundary of the oil phase, significantly enhancing fine particle flotation efficiency. Therefore, the special flotation separation reagent combination adopted in the present disclosure may effectively solve the problem in the prior art that special flotation separation equipment must be used for coarse particle copper ore and fine particle copper ore.

The manner of the present disclosure is described in detail below in combination with specific embodiments. In the following EXAMPLES and COMPARATIVE EXAMPLES, all raw materials used are ordinary commercially available products that may be directly purchased or may be prepared according to conventional techniques in the art.

### Example 1

The copper content in a test ore sample is 0.34 wt %. The test ore sample is from the Pulang Copper Mine in Yunnan Province. Process mineralogy research results show that main metal ore in the ore sample includes pyrite and chalcopyrite. A flotation recovery method for a full particle size copper ore provided in the present disclosure was used to perform a laboratory small-scale closed-circuit test on the ore sample. Specific test steps were as follows:
1) The ore sample was ground to a fineness of 60% passing 74 μm. After grinding, lime was added as a regulator to adjust a slurry pH to 8.5. Subsequently, 40 g/t of Z-200 was added as a collector, and 10 g/t of oil No. 2 (the pine oil) was added as a frother to perform copper roughing to obtain a copper rough concentrate and copper rough tailings.
2) The copper rough tailings obtained in step 1) were classified using a high-frequency vibrating screen to obtain a +200 mesh slurry product, a 200-400 mesh slurry product, and a −400 mesh slurry product, i.e., three particle size slurry products.
3) The +200 mesh slurry product obtained in step 2) (with a slurry concentration of 30%) was subjected to coarse particle flotation. A combined collector of diisopropyl xanthogen disulfide and isopropyl xanthate at a mass ratio of 2:1 was used as the collector at a dosage of 20 g/t, to obtain a rough concentrate of the coarse particle flotation and tailings of the coarse particle flotation. The rough concentrate of the coarse particle flotation was returned to the raw ore grinding operation.
4) The −400 mesh slurry product obtained in step 2) was subjected to fine particle rougher flotation. A combined collector of butyl xanthate and diesel oil at a mass ratio of 1:1 was used as the collector at a dosage of 30 g/t. The slurry concentration during the flotation process was 25%, and the stirring speed of the flotation cell was 2300 rpm. After the rougher flotation, a rough concentrate of fine particle flotation and tailings of the fine particle rougher flotation were obtained.
5) The copper rough concentrate obtained in step 1) and the rough concentrate of fine particle flotation obtained in step 4) were combined and subjected to blank cleaning twice to obtain a copper concentrate.
6) The tailings of the fine particle rougher flotation obtained in step 4) were subjected to scavenging twice. The first scavenging added 15 g/t of the combined collector of butyl xanthate and diesel oil (mass ratio 1:1). The second scavenging added 7 g/t of the combined collector of butyl xanthate and diesel oil (mass ratio 1:1) to obtain tailings of fine particle flotation. The tailings of fine particle flotation were combined with the 200-400 mesh slurry product in step 2) and the tailings of the coarse particle flotation in step 3) to obtain final flotation tailings.

Test results are shown in Table 1.

It shows that using the flotation recovery method for the full particle size copper ore provided in the present disclosure, the laboratory small-scale closed-circuit test can obtain a copper concentrate with a copper grade of 22.36% and a copper recovery rate of 87.26%.

TABLE 1

| Product Name | Yield/% | Cu Grade/% | Cu Recovery/% |
|---|---|---|---|
| Copper concentrate | 1.33 | 22.36 | 87.26 |
| Tailings | 98.67 | 0.044 | 12.74 |
| Raw Ore | 100.00 | 0.34 | 100.00 |

### Example 2

Other conditions are consistent with EXAMPLE 1, with the difference being that the fine particle flotation collector was butyl xanthate+pentyl xanthate+diesel oil at a mass ratio of 0.5:0.5:1.

Test results are shown in Table 2.

It shows that using the flotation recovery method for the full particle size copper ore provided in the present disclosure, the laboratory small-scale closed-circuit test can obtain a copper concentrate with a copper grade of 21.58% and a copper recovery rate of 88.10%.

TABLE 2

| Product Name | Yield/% | Cu Grade/% | Cu Recovery Rate/% |
|---|---|---|---|
| Copper concentrate | 1.42 | 21.58 | 88.10 |
| Tailings | 98.58 | 0.042 | 11.90 |
| Raw Ore | 100.00 | 0.35 | 100.00 |

### Example 3

Other conditions are consistent with EXAMPLE 1, with the difference being that the coarse particle flotation collector is a combined collector of diisopropyl xanthogen disulfide and isopropyl xanthate at a mass ratio of 3:1.

Test results are shown in Table 3.

It shows that using the flotation recovery method for the full particle size copper ore provided in the present disclosure, a laboratory small-scale closed-circuit test can obtain a copper concentrate with a copper grade of 22.25% and a copper recovery rate of 87.12%.

TABLE 3

| Product Name | Yield/% | Cu Grade/% | Cu Recovery Rate/% |
|---|---|---|---|
| Copper concentrate | 1.35 | 22.25 | 87.12 |
| Tailings | 98.65 | 0.045 | 12.88 |
| Raw Ore | 100.00 | 0.34 | 100.00 |

### Example 4

Other conditions are consistent with EXAMPLE 1, with the difference being that the fine particle flotation collector is a combined collector of isopentyl xanthate, kerosene, and transformer oil at a mass ratio of 1:1:1.

Test results are shown in Table 4.

It shows that using the flotation recovery method for the full particle size copper ore provided in the present disclosure, a laboratory small-scale closed-circuit test can obtain a copper concentrate with a copper grade of 22.53% and a copper recovery rate of 87.51%.

TABLE 4

| Product Name | Yield/% | Cu Grade/% | Cu Recovery Rate/% |
|---|---|---|---|
| Copper concentrate | 1.32 | 22.53 | 87.51 |
| Tailings | 98.68 | 0.043 | 12.49 |
| Raw Ore | 100.00 | 0.34 | 100.00 |

### Example 5

A copper content of a test ore sample is 0.50 wt %. Process mineralogy research results show that main metallic ore in the ore sample includes pyrite, chalcopyrite, bornite, and chalcocite. A flotation recovery method for a full particle size copper ore provided in the present disclosure is used to perform a laboratory small-scale closed-circuit test on the ore sample. Specific test steps were as follows.
1) The ore sample was ground to a fineness of 65% passing 74 μm. After grinding, sodium sulfide was added as a regulator to adjust a slurry pH to 9.0. Subsequently, a combined collector of ethyl xanthate+ammonium dibutyl dithiophosphate with a mass ratio of 1:1 at 50 g/t and MIBC at 10 g/t as a frother were added to perform copper roughing to obtain a copper rough concentrate and copper rough tailings.
2) The copper rough tailings obtained in step 1) were classified by a hydraulic classifier to obtain a +200 mesh slurry product, a 200-400 mesh slurry product, and a −400 mesh slurry product, which were three particle size slurry products.
3) The +200 mesh slurry product obtained in step 2) (with a slurry concentration of 35%) was subjected to coarse particle flotation. A combined collector of diisopropyl xanthogen disulfide+isopropyl xanthate with a mass ratio of 1:1 was used as a collector at a dosage of 30 g/t. A rough concentrate of the coarse particle flotation and tailings of the coarse particle flotation were obtained. The rough concentrate of the coarse particle flotation was returned to a raw ore grinding operation.
4) The −400 mesh slurry product obtained in step 2) was subjected to fine particle rougher flotation. A combined collector of pentyl xanthate+heavy oil with a mass ratio of 2:1 was used as a collector at a dosage of 40 g/t. A slurry concentration during the flotation process was 23%. A stirring speed of a flotation cell was 2200 rpm. After the rougher flotation, a rough concentrate of fine particle flotation and tailings of the fine particle rougher flotation were obtained.
5) The copper rough concentrate obtained in step 1) and the rough concentrate of fine particle flotation obtained in step 4) were combined. Blank cleaning was performed twice to obtain a copper concentrate.
6) The tailings of the fine particle rougher flotation obtained in step 4) were subjected to scavenging twice. For a first scavenging, a combined collector of butyl xanthate+diesel oil (with a mass ratio of 1:1) at 20 g/t was added. For a second scavenging, the combined collector of butyl xanthate+diesel oil (with a mass ratio of 1:1) at 10 g/t was added to obtain tailings of fine particle flotation. The tailings of fine particle flotation, the 200-400 mesh slurry product in step 2), and the tailings of the coarse particle flotation in step 3) were combined to serve as final flotation tailings.

Test results are shown in Table 5.

It shows that using the flotation recovery method for the full particle size copper ore provided in the present disclosure, a laboratory small-scale closed-circuit test can obtain the copper concentrate with a copper grade of 24.52% and a copper recovery rate of 88.11%.

TABLE 5

| Product Name | Yield/% | Cu Grade/% | Cu Recovery/% |
|---|---|---|---|
| Copper concentrate | 1.81 | 24.52 | 88.11 |
| Tailings | 98.19 | 0.061 | 11.89 |
| Raw Ore | 100.00 | 0.50 | 100.00 |

### Comparative Example 1

The test ore sample is the same as that in EXAMPLE 1, with the difference being that a non-classification flotation process is used to perform a laboratory small-scale closed-circuit test.

Specific test steps were as follows.
1) The ore sample was ground to a fineness of 60% passing 74 μm. After grinding, lime was added as a regulator to adjust a slurry pH to 8.5. Subsequently, 40 g/t of Z-200 was added as a collector and 10 g/t of oil No. 2 was added as a frother to perform copper roughing to obtain a copper rough concentrate and copper rough tailings.
2) The copper rough tailings obtained in step 1) were subjected to scavenging twice. For a first scavenging Z-200 at 20 g/t was added. For a second scavenging Z-200 at 10 g/t was added. Scavenging tailings served as final flotation tailings.
3) The copper rough concentrate obtained in step 1) was subjected to blank cleaning twice to obtain the copper concentrate.

Test results are shown in Table 6.

It shows that, after using a conventional process flow, the copper concentrate with a copper grade of 22.17% and a copper recovery rate of 83.94% was obtained in a laboratory small-scale closed-circuit test. Compared with the flotation recovery method for the full particle size copper ore provided in the present disclosure, it shows that after canceling coarse and fine particle flotation processes and reagents, the copper concentrate recovery rate shows a significant decrease.

TABLE 6

| Product Name | Yield/% | Cu Grade/% | Cu Recovery/% |
|---|---|---|---|
| Copper concentrate | 1.28 | 22.17 | 83.94 |
| Tailings | 98.72 | 0.055 | 16.06 |
| Raw ore | 100.00 | 0.34 | 100.00 |

### Comparative Example 2

Other conditions are consistent with EXAMPLE 1, with the difference being that the collector for the coarse particle flotation is isopropyl xanthate.

Test results are shown in Table 7.

It shows that, after removing diisopropyl xanthogen disulfide from the collector for the coarse particle flotation, a copper concentrate with a copper grade of 22.55% and a copper recovery rate of 85.84% was obtained in a laboratory small-scale closed-circuit test. A comparison shows that after canceling the addition of diisopropyl xanthogen disulfide, the loss of coarse copper ore increases, and the recovery rate of the copper concentrate decreases by 1.42 percentage points.

TABLE 7

| Product Name | Yield/% | Cu Grade/% | Cu Recovery Rate/% |
|---|---|---|---|
| Copper concentrate | 1.30 | 22.55 | 85.84 |
| Tailings | 98.70 | 0.049 | 14.16 |
| Raw ore | 100.00 | 0.34 | 100.00 |

### Comparative Example 3

Other conditions are consistent with EXAMPLE 1, with the difference being that the collector for the coarse particle flotation is diisopropyl xanthogen disulfide.

Test results are shown in Table 8.

It shows that, after removing isopropyl xanthate from the collector for the coarse particle flotation, a copper concentrate with a copper grade of 21.88% and a copper recovery rate of 85.60% was obtained in a laboratory small-scale closed-circuit test. A comparison shows that after canceling the addition of isopropyl xanthate, the loss of coarse copper ore increases, and the recovery rate of the copper concentrate decreases by 1.66 percentage points.

TABLE 8

| Product Name | Yield/% | Cu Grade/% | Cu Recovery Rate/% |
|---|---|---|---|
| Copper concentrate | 1.34 | 21.88 | 85.60 |
| Tailings | 98.66 | 0.050 | 14.40 |
| Raw ore | 100.00 | 0.34 | 100.00 |

### Comparative Example 4

Other conditions are consistent with EXAMPLE 1, with the difference being that the fine particle flotation collector is butyl xanthate.

Test results are shown in Table 9.

It shows that after diesel oil is removed from the fine particle flotation collector, a copper concentrate with a copper grade of 22.63% and a copper recovery rate of 85.63% was obtained in a laboratory small-scale closed-circuit test. A comparison shows that after canceling the addition of diesel oil, the loss of fine copper ore increases, and the recovery rate of the copper concentrate decreases by 1.63 percentage points.

TABLE 9

| Product Name | Yield/% | Cu Grade/% | Cu Recovery Rate/% |
|---|---|---|---|
| Copper concentrate | 1.30 | 22.63 | 85.63 |
| Tailings | 98.70 | 0.050 | 14.37 |
| Raw Ore | 100.00 | 0.34 | 100.00 |

### Comparative Example 5

Other conditions are consistent with EXAMPLE 1, with the difference being that the fine particle flotation collector is diesel oil.

Test results are shown in Table 10.

It shows that after butyl xanthate is removed from the fine particle flotation collector, a copper concentrate with a copper grade of 22.98% and a copper recovery rate of 84.94% was obtained in a laboratory small-scale closed-circuit test. A comparison shows that after canceling the addition of butyl xanthate, the loss of fine copper ore increases, and the recovery rate of the copper concentrate decreases by 2.32 percentage points.

TABLE 10

| Product Name | Yield/% | Cu Grade/% | Cu Recovery Rate/% |
|---|---|---|---|
| Copper concentrate | 1.26 | 22.98 | 84.94 |
| Tailings | 98.74 | 0.052 | 15.06 |
| Raw Ore | 100.00 | 0.34 | 100.00 |

### Comparative Example 6

Other conditions are consistent with EXAMPLE 1, with the difference being that the coarse particle flotation collector uses a combined collector of diisopropyl xanthogen disulfide and isopropyl xanthate with a mass ratio of 4:1.

Test results are shown in Table 11.

It shows that after the mass ratio of diisopropyl xanthogen disulfide to isopropyl xanthate in the coarse particle flotation collector is changed to 4:1, a copper concentrate with a copper grade of 22.26% and a copper recovery rate of 86.28% was obtained in a laboratory small-scale closed-circuit test. A comparison shows that after changing the mass ratio of diisopropyl xanthogen disulfide to isopropyl xanthate in the coarse particle flotation collector, the loss of coarse particle copper ore increases, and the recovery rate of the copper concentrate decreases by 0.98 percentage points.

TABLE 11

| Product Name | Yield/% | Cu Grade/% | Cu Recovery/% |
|---|---|---|---|
| Copper concentrate | 1.31 | 22.26 | 86.28 |
| Tailings | 98.69 | 0.047 | 13.72 |
| Raw Ore | 100.00 | 0.34 | 100.00 |

### Comparative Example 7

Other conditions are consistent with EXAMPLE 1, with the difference being that the fine particle flotation collector uses a combined collector of butyl xanthate and diesel oil at a mass ratio of 3:1.

Test results are shown in Table 12.

It shows that after changing the mass ratio of the butyl xanthate to the diesel oil in the fine particle flotation collector to 3:1, a copper concentrate with a copper grade of 22.07% and a copper recovery rate of 86.11% was obtained in a laboratory small-scale closed-circuit test. A comparison shows that after changing the mass ratio of the butyl xanthate to the diesel oil in the fine particle flotation collector, the loss of fine particle copper ore increases, and the recovery rate of the copper concentrate decreases by 1.15 percentage points.

TABLE 12

| Product Name | Yield/% | Cu Grade/% | Cu Recovery/% |
|---|---|---|---|
| Copper concentrate | 1.33 | 22.07 | 86.11 |
| Tailings | 98.67 | 0.048 | 13.89 |
| Raw Ore | 100.00 | 0.34 | 100.00 |

The present disclosure has the following beneficial effects:

First, copper ore is recovered by classification. 200-400 mesh particle size copper ore is recovered by conventional flotation means, while +200 mesh and −400 mesh particle size copper ore are recovered by coarse particle flotation technology and fine particle flotation technology, respectively. This not only ensures efficient recovery of easily floatable copper ore but also enhances the recovery of coarse and fine particle size copper ore, effectively improving the flotation recovery rate.

Second, stable adhesion between particles and bubbles is particularly important in a coarse particle flotation process. The use of a combined collector of diisopropyl xanthogen disulfide and isopropyl xanthate achieves a synergistic effect. On one hand, the branched chain structure in the hydrophobic hydrocarbon chain of diisopropyl xanthogen disulfide can form a chelation-like effect with bubbles, improving the adhesion strength between coarse particle copper ore and bubbles. On the other hand, isopropyl xanthate interacts strongly with copper ore particles. The combination of isopropyl xanthate and the copper ore particles promotes the stability and adhesion of the interaction between diisopropyl xanthogen disulfide and bubbles.

Third, the use of a combined collector of long-chain alkyl xanthate and neutral oil in the fine particle flotation process achieves a synergistic effect. On one hand, the long-chain alkyl xanthate can promote the interaction between fine particle copper ore and the collector, improving the hydrophobicity of fine particle copper ore. On the other hand, the addition of neutral oil can achieve the aggregation of hydrophobic fine particle copper ore within or at the boundary of the oil phase, promoting fine particle flotation efficiency.

Fourth, this flotation process and reagent regime have strong applicability, which can relax the grinding fineness requirement for the raw ore, and are beneficial for ensuring production stability and reducing ore processing costs.

Fifth, through the combination of the flotation separation manner and the reagent regime of the present disclosure, the problem in the prior art that special flotation separation equipment must be used for coarse copper ore particles and fine copper ore particles can be effectively solved.

What is claimed is:

1. A flotation recovery method for a full particle size copper ore, comprising the following steps:
a) performing grinding and dissociation treatment on a copper raw ore, adding a flotation reagent, and performing flotation, wherein the flotation includes primary roughing to obtain a copper rough concentrate and copper rough tailings;
b) performing classification on the copper rough tailings to obtain a +200 mesh slurry product, a 200-400 mesh slurry product, and a −400 mesh slurry product, which are three particle size slurry products;
c) adding a combined collector of diisopropyl xanthogen disulfide and isopropyl xanthate to the +200 mesh slurry product and performing coarse particle flotation to obtain a rough concentrate of the coarse particle flotation and tailings of the coarse particle flotation, wherein a mass ratio of diisopropyl xanthogen disulfide to isopropyl xanthate in the combined collector of diisopropyl xanthogen disulfide and isopropyl xanthate is (3-1):1;
d) performing fine particle rougher flotation on the −400 mesh slurry product, adding a fine particle flotation collector during a process of the fine particle rougher flotation to obtain a rough concentrate of fine particle flotation and tailings of the fine particle rougher flotation, combining the rough concentrate of fine particle flotation with the copper rough concentrate obtained in step a), and performing blank cleaning to obtain a copper concentrate; performing scavenging on the tailings of the fine particle rougher flotation to obtain tailings of fine particle flotation, wherein the fine particle flotation collector includes a long-chain alkyl xanthate and a neutral oil at a mass ratio of (1-2):(1-2), the long-chain alkyl xanthate includes at least one of butyl xanthate, pentyl xanthate, and isopentyl xanthate; and the neutral oil includes at least one of kerosene, diesel oil, transformer oil, lubricating oil, and heavy oil; and
e) combining the 200-400 mesh slurry product, the tailings of the coarse particle flotation obtained in step c), and the tailings of fine particle flotation obtained in step d) as final flotation tailings.

2. The method according to claim 1, wherein in step a), a product fineness of the grinding and dissociation treatment is 50%-75% passing 74 μm; and during the primary roughing of the flotation, a regulator, a collector I, and a frother are added to promote flotation.

3. The method according to claim 2, wherein:
the regulator includes at least one of sodium hydroxide, lime, sodium sulfide, sodium hydrosulfide, sodium metabisulfite, and sodium carbonate, and is used in an amount to adjust a slurry pH to 7.5-9.5;
the collector I includes at least one of a xanthate collector, a thiocarbamate collector, a dithiophosphate collector, and a dithiocarbamate collector, and is used in an amount of 10-100 g/t; and
the frother is at least one of oil No. 2 and Methyl Isobutyl Carbinol (MIBC), and is used in an amount of 5-30 g/t.

4. The method according to claim 1, wherein the classification is performed using at least one of a high-frequency vibrating screen, a hydrocyclone, a spiral classifier, a hydraulic classifier, and a mud bucket.

5. The method according to claim 4, wherein a total dosage of the combined collector of diisopropyl xanthogen disulfide and isopropyl xanthate is 10-50 g/t.

6. The method according to claim 5, wherein a total dosage of the fine particle flotation collector during the fine particle rougher flotation is 20-50 g/t; a total dosage of the fine particle flotation collector during the scavenging is 7-20 g/t; and the fine particle flotation collector used during the fine particle rougher flotation and the fine particle flotation collector used during the scavenging are of a same type or different types.

7. The method according to claim 1, wherein:
in step d), a slurry concentration of the fine particle rougher flotation is 20-30%, and a stirring speed of a flotation cell is 2000-2400 rpm; and
in step c), a slurry concentration of the coarse particle flotation is 20-50%.
